(19) United States
(12) Patent Application Publication
(10) Pub. No.: US 2010/0315259 A1
(43) Pub. Date: Dec. 16, 2010

(54) POSITION DETERMINING SYSTEM

(76) Inventors: Timo Galm, Mudau (DE); Thomas Freund, Mannheim (DE)

Correspondence Address: Muncy, Geissler, Olds & Lowe, PLLC, 4000 Legato Road, Suite 310, FAIRFAX, VA, 22033, US

(21) Appl. No.: 12/813,195

(22) Filed: Jun. 10, 2010

Related U.S. Application Data
(60) Provisional application No. 61/185,966, filed on Jun. 10, 2009.

(30) Foreign Application Priority Data
Jun. 10, 2009 (EP) EP 09007681.1

(51) Int. Cl. G08B 5/22

(52) U.S. Cl. 340/825.49

(57) ABSTRACT

A position determining system with a sensor unit and a transducer unit, the sensor unit comprises a first RFID transponder reader unit and a first induction detection unit, the transducer unit comprises an RFID transponder and a metallic material, the sensor unit is movable relative to the transducer unit, and the position of the sensor unit can be determined using the data determined by the transducer unit.

This nonprovisional application claims priority to EP Patent Application No. 09007681.1, which was filed on Jun. 10, 2009, and to U.S. Provisional Application No. 61/185,966, which was filed on Jun. 10, 2009, and which are both herein incorporated by reference.

### BACKGROUND OF THE INVENTION

1. Field of the Invention

The invention relates to a position determining system, a use of the position determining system, and a method of determining the position.

2. Description of the Background Art

A system is known from German Pat. Appl. No. DE 10 2006 004 938 A1. The position determining system described therein is used, for example, for determining the position of a motor vehicle. RFID transponders are used preferably for this purpose. Another position determining system is known from Int. Pat. Appl. No. WO 2008/101702. In this case, to determine the position of a rotating wheel, the induction in a sensor of the magnets arranged on the rotating wheel is determined.

Another position determining system is known from the German Pat. Appl. No. DE 10 2008 044 739 A1, which is incorporated herein by reference. Here, the position of a first object relative to a second object is determined by means of an inductive displacement sensor. To this end, a sensor unit passes near a marking section realized as a transducer unit, whereby the marking section has a plurality of metallic material sections of variable width. The metallic materials of variable size generate an induction of different strength.

Another device and a method for determining the position are known from Int. Pat. Appl. No. WO 2005/012840, which corresponds to U.S. Pat. No. 7,245,121, and which is incorporated herein by reference. Based on the method described therein, by means of a sensor, the induction brought about by permanent magnets in the sensor is evaluated, whereby a sensor unit arranged on a read head is capable of determining the induction of a plurality of magnets simultaneously.

Further, a roller used as a transducer unit in printing technology, which also has an RFID transponder apart from a magnet as a reference mark, is known from German Utility Model No. DE 20 2007 004 717 U1. By means of the RFID transponder, the roller data stored in the transponder are read out by the sensor unit, whereas the rotational position of the rollers can be determined by the reference marks.

Furthermore, a position determining system is also known from Int. Pat. Appl. No. WO 2005/052842, which corresponds to U.S. Pat. No. 7,600,613.

A drawback in some of the conventional position determining systems is that the position can be determined only imprecisely and/or the position determining systems are cost-intensive during manufacture and use, particularly when, for example, in the case of crane units in harbor areas several 100 m must be traversed by the crane and the precise position is to be determined simultaneously. This also applies during use as a speed sensor in rings with diameters greater than several meters.

### SUMMARY OF THE INVENTION

It is therefore an object of the present invention to provide a position determining system, a use thereof, and a method for determining the position, which in each case reduce the disadvantages of the prior art.

According to an embodiment, a position determining system with a sensor unit and a transducer unit is provided, in which the sensor unit comprises a first RFID transponder reader unit and a first induction detector unit, the transducer unit comprises an RFID transponder and a metallic material, the sensor unit is movable relative to the transducer unit, and the position of the sensor unit can be determined by means of the data determined by the sensor unit from the transducer unit.

According to another embodiment of the invention, a use of the position determining system is disclosed for determining the position along a guiding device of a positively guided vehicle, particularly a rail vehicle, which preferably can also be movable on a circular ring.

According to yet a further embodiment of the invention, a method is provided for determining the position with a sensor unit, which comprises at least one RFID transponder reader unit, and an induction detector unit and a transducer unit, which comprises an RFID transponder and a metallic material, wherein a plurality of transducer units are arranged in a row, and in the case of a displacement of the sensor unit relative to the transducer units, the position of the sensor unit relative to the transducer units is determined from the data read by means of the RFID transponder and the induction from the metallic material.

An advantage of the position determining system according to the invention is that by means of the combination of two different types of sensors or transducers, the accuracy of the position determination of the reader unit, particularly also at great distances greater than 10 m, preferably greater than 100 m, can be increased in that position data can be determined by a row arrangement of two different types of transducers, namely, an RFID transponder and a metallic material. Tests by the applicant have shown that using RFID transponders opens up a simple and reliable possibility to provide the RFID transponder reader unit with the necessary data simply and reliably. In this case, it is advantageous to use simple cost-effective passive RFID transponders, which do not have their own current supply. The RFID transponders preferably operate within the range of 125 KHz, most preferably in the range of 13.56 MHz, and obtain their necessary power from the field of the sensor unit. HF RFID transponders as well, which operate backscatter-based within the range above 800 MHz, can also preferably be used. The individual RFID transponders have a unique identification by which a position can be assigned to the particular RFID transponder in the sensor unit. The assignments can be made especially easily when the particular RFID transponder has a consecutive sequence of numbers. In this way, an absolute position can be easily determined by the RFID transponder reader unit from the RFID transponder data and in addition by means of the induction detector unit due to a change in the induction in the vicinity of a metallic material, at least one relative position of the sensor unit with respect to the RFID transponder can be determined; i.e., the position can be determined very precisely from a combination of RFID transponder data and the change in induction caused by the metallic material. It is understood that metallic materials that cause an especially strong induction in a magnetic field are to be preferred.

As the position determining system determines the data of the transducer unit without contact and without optical aids, the system is robust and not sensitive to soiling. Furthermore, particularly during use in security-related systems, in each position an RFID transponder can be read out, and as a result the absolute position of the reader unit can be determined without a reference point having to be approached or the last position having to be stored. This is an advantage particularly during a power outage.

In an embodiment, the sensor unit can comprise a second RFID transponder reader unit. In a suitable arrangement, the reader unit can read the data of two RFID transponders, as a result of which the security and accuracy during the position determination increase. Particularly if the signal of a RFID transponder were to fail, because of the redundancy during reading the position can continue to be determined precisely. The sensor unit can be used especially advantageously in security-related systems because of the redundancy of the sensors arranged on the sensor unit. If, for example, the induction detector unit fails, the position, albeit possibly with a lower accuracy, can continue to be determined reliably with use of one or both RFID transponder reader units.

Because of a row arrangement of a plurality of transducer units and the design of an alternating arrangement of RFID transponder and metallic materials, the position determining system can also be used preferably for a precise determination of the position, also in the case of lengths of several 100 m. Tests by the applicant have shown that the position can be determined up to values smaller than 1 mm.

In another embodiment, it is preferable to arrange at least one piece, preferably also two or more pieces of metallic material between two RFID transponders. It is preferred, further, to make the transducer units of a flexible support material and to form the flexible support material as a strip, so that it can be unrolled from a roll.

According to another embodiment, it is preferred to arrange the support material on a bar, whereby an RFID transponder each is formed at the end and beginning of the bar. Tests by the applicant have shown that the strip, i.e., the transducer units, can be attached cost-effectively and continuously to a bar, for example, by means of a gluing process. If the sensor unit is arranged on a rail vehicle, the position of the rail vehicle can be determined simply and reliably. The term rail vehicle covers all positively guided systems, regardless of the geometric configuration. Tests by the applicant have shown in particular that the positioning system of the invention can be used preferably in rings with a diameter greater than several meters.

In an embodiment, the sensor unit comprises evaluation electronics, whereby the sensor unit has such a length that at each position both the data of at least one RFID transponder are determined and the induction of at least one metallic material is received. In this case, it is preferred to determine a rough position by means of the RFID transponder data by the sensor unit and by means of the induction data of the induction detector unit caused by the change in the induction of a transmitted magnetic field by the metallic material, as a result of induction of an eddy current in the metallic material, a fine position of the sensor unit is determined.

In an embodiment, the metallic material can also be made as a permanent magnet. As a result, the sending out of a variable magnetic field by the induction detector unit is unnecessary. Instead, a Hall sensor is necessary for detecting the magnetic field.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a top view of a first embodiment of a row arrangement of a plurality of transducer units;

FIG. 2 shows a top view of a first embodiment of a reader unit;

FIG. 3 shows a side view of a position determining system of the invention;

FIG. 4 shows a top view of a second embodiment of a row arrangement of a plurality of transducer units; and

FIG. 5 shows a top view of a second embodiment of a reader unit.

### DETAILED DESCRIPTION

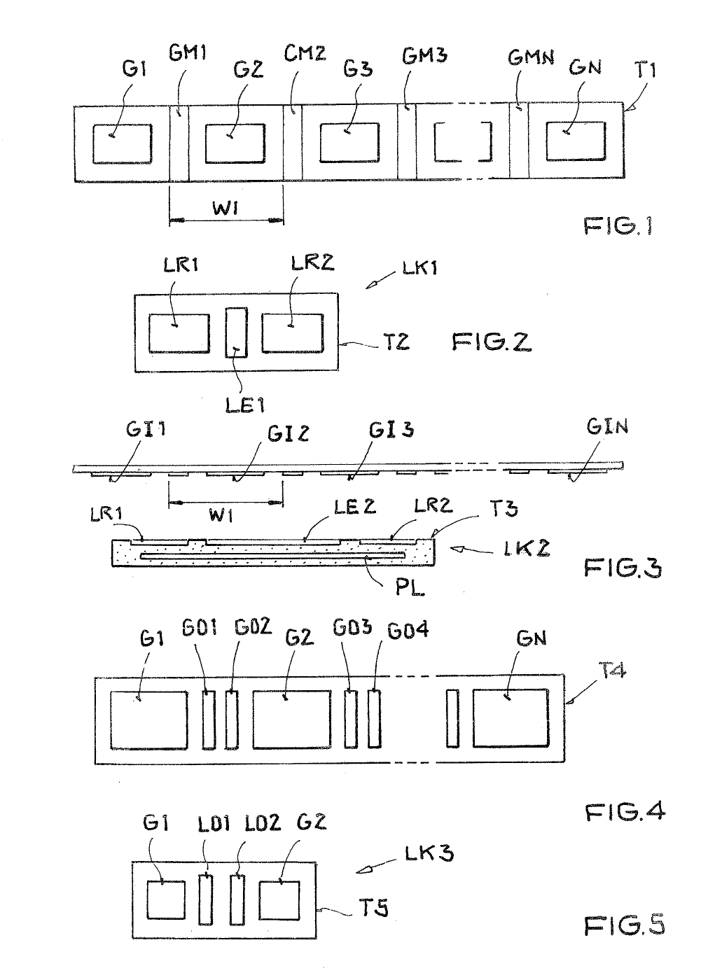

The illustration in FIG. 1 shows a top view of a first schematic embodiment of a row arrangement of transducer units arranged on a support T1. The support T1 is formed preferably as a flexible strip which preferably can be unrolled from a roll. A first transducer unit GK1 includes an RFID transponder G1 and a metallic material GM1. Accordingly, the following transducer units comprise an RFID transponder G2 and a metallic material GM2 or an RFID transponder G3 and a metallic material GM3, and the last transducer unit an RFID transponder GMN-1 and a metallic material GMN-1. The row arrangement of transducer units, which represents an alternating arrangement of RFID transponders and metallic materials, is ended by an RFID transponder GN. The length of a transducer unit is W1 and simultaneously represents the degree of repetition in the row arrangement of transducer units. So that the degree of repetition does not vary if possible from transducer unit to transducer unit and the accuracy of the position determination is not negatively affected, the strip is to be made as nonexpandable as possible in the longitudinal direction.

The illustration in FIG. 2 shows a top view of a schematic embodiment of a sensor unit LK1. The sensor unit LK1 comprises a first RFID transponder reader unit LR1, a first induction detector unit LE1, and a second RFID transponder sensor unit LR2. Further, the reader units are arranged on a support T2.

The illustration in FIG. 3 shows a schematic side view of a position determining system of the invention, having a row arrangement of transducer units, as already explained in relation to the drawing documents depicted in FIG. 1, and a sensor unit LK2 with the first RFID transponder reader unit LR1 and a first induction detector unit LE2 and the second RFID transponder reader unit LR2 arranged on a support T3. Further, the sensor unit LK2 comprises a plate PL likewise arranged on support T3 for accommodating evaluation electronics. The distance of the sensor unit LK2 to the transducer units arranged on the top side of support T1 is selected in such a way that the data of the RFID transponder and the change in induction due to the metallic material are reliably determined. The distance is preferably within the range of a few centimeters. Further, the sensor unit LK2 can be moved relative to the row arrangement of transducer units.

The illustration in FIG. 4 shows a top view of a second schematically depicted embodiment of a row arrangement of transducer units which are formed on a support T4. Hereafter, only the differences to the first embodiment, explained in relation to the description of the illustration in FIG. 1, are described. Accordingly, a transducer unit GK2 comprises the transponder G1 and two successive areas with a metallic material G01 and G02. The distances between the metallic materials are selected in such a way that the sensor unit can achieve the best possible spatial resolution.

In the illustration in FIG. 5, a top view of a second schematically depicted embodiment of a sensor unit LK3, arranged on a support T5, is shown. Hereafter, only the differences to the first embodiment, explained in relation to the description of the illustration in FIG. 2, are described. Accordingly, a sensor unit LK3 comprises a first induction detector unit LO1 and a second induction detector unit LO2. Both induction detector units LO1 and LO2 are formed between the two RFID transponder reader units LR1 and LR2. The arrangement of the two induction detector units LO1 and LO2 is adapted particularly to the second embodiment of a transducer unit, shown in FIG. 4, to detect the two metallic materials arranged between the RFID transponders.

Further, the sensor unit LK3 can also be used for the embodiment of a transducer unit with only one metallic material arranged between two RFID transponders. Likewise, the sensor unit LK2 or LK1 can also be used for the transducer unit, explained in relation to the drawing documents of FIG. 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A position determining system comprising:
a transducer unit having an RFID transponder, the transducer unit comprising a metallic material; and
a sensor unit having a first RFID transponder reader unit, the sensor unit being movable relative to the transducer unit, the sensor unit comprising a first induction detector unit,
wherein, the position of the sensor unit is determined by the sensor unit based on data determined by two different types of transducers.

2. The position determining system according to claim 1, wherein the sensor unit comprises a second RFID transponder reader unit.

3. The position determining system according to claim 1, wherein the position is determined via a combination of RFID transponder data and an induction from the metallic material.

4. The position determining system according to claim 1, wherein a plurality of transducer units are arranged in a row and an alternating arrangement of RFID transponder and metallic materials is formed.

5. The position determining system according to claim 1, wherein at least one metallic material is arranged between two RFID transponders.

6. The position determining system according to claim 1, wherein the transducer units are formed on a flexible support material.

7. The position determining system according to claim 1, wherein the flexible support material is formed as a strip and is unrolled from a roll.

8. The position determining system according to claim 1, wherein the support material is arranged on a bar, and wherein an RFID transponder is formed at each end and beginning of the bar.

9. The position determining system according to claim 1, wherein the sensor unit is arranged on a rail vehicle.

10. A use of the position determining system according to claim 1 for determining the position along a guiding device of a positively guided vehicle or a rail vehicle.

11. A method for determining a position with a sensor unit, which comprises at least one RFID transponder reader unit and an induction detector unit, and a transducer unit, which comprises an RFID transponder and a metallic material, the method comprising:
arranging a plurality of transducer units in a row; and
determining, in a case of a displacement of the sensor unit relative to the transducer units, the position of the sensor unit relative to the transducer units from data read by the RFID transponder and an induction from the metallic material.

12. The method for determining the position according to claim 11, wherein the sensor unit comprises evaluation electronics and at each position of the sensor unit both the data of at least one RFID transponder and the induction of, at least one metallic material are determined.

13. The method for determining the position according to claim 11, wherein a rough position of the sensor unit is determined by the RFID transponder data.

14. The method for determining the position according to claim 11, wherein a fine position of the sensor unit is determined by the induction of the metallic material.

15. The position determining system according to claim 1, wherein the transducer has a plurality of metallic materials, and wherein, based on a variable size of the metallic materials, an induction of different strength is generated.
